(19) United States
(12) Patent Application Publication
(10) Pub. No.: US 2024/0123866 A1
(43) Pub. Date: Apr. 18, 2024

(54) METHOD FOR EQUALIZING BATTERY CAPACITIES OF VEHICLE, ELECTRONIC DEVICE, AND VEHICLE

(71) Applicant: BYD COMPANY LIMITED, SHENZHEN (CN)

(72) Inventors: Saiwu LIU, Shenzhen (CN); Zhihua CHENG, Shenzhen (CN); Lina YANG, Shenzhen (CN); Yanjun CHEN, Shenzhen (CN)

(21) Appl. No.: 18/531,164

(22) Filed: Dec. 6, 2023

Related U.S. Application Data
(63) Continuation of application No. PCT/CN2022/106672, filed on Jul. 20, 2022.

(30) Foreign Application Priority Data
Sep. 23, 2021 (CN) 202111116890.9

(51) Int. Cl. B60L 58/22; B60L 58/12; B60L 58/21

(52) U.S. Cl. CPC B60L 58/22; B60L 58/12; B60L 58/21; B60L 2200/26

(57) ABSTRACT

A method for equalizing battery capacities of a vehicle includes: determining, based on a current capacity of a battery of each of carriages, a largest battery capacity and a corresponding first carriage thereof, and a smallest battery capacity and a corresponding second carriage thereof; determining, based on the largest battery capacity and the smallest battery capacity, a first traction force and a second traction force, where the first traction force is greater than the second traction force; and outputting a first control command including the first traction force to the first carriage, and outputting a second control command including the second traction force to the second carriage for equalizing battery capacities of the carriages of the vehicle.

### CROSS-REFERENCE TO RELATED APPLICATIONS

This application is a Continuation Application of International Patent Application No. PCT/CN2022/106672, filed on Jul. 20, 2022, which is based on and claims priority to and benefits of Chinese Patent Application No. 202111116890.9, filed on Sep. 23, 2021. The entire content of all of the above-referenced applications is incorporated herein by reference.

### FIELD

Embodiments of the present disclosure relate to the field of electric vehicle energy control technologies, and more particularly, relate to a method for equalizing battery capacities of a vehicle, an electronic device, and a vehicle.

### BACKGROUND

In a multi-marshalling vehicle powered by a power battery, such as a rail vehicle or a bus, a battery pack assembly is arranged in each carriage. The power of each carriage sources from the battery pack in the carriage. The battery packs in carriages are independent of and isolated from each other, as shown in FIG. 1. During the actual operation, power consumptions of the battery packs in different carriages are inconsistent. Reasons for the inconsistency in the power consumptions of the battery packs in different carriages include that power consumptions of the carriages are different, initial capacities of the battery pack are inconsistent, virtual electricity in the battery packs caused by internal battery inconsistencies or a detection error, and the like.

In the related art, for a running vehicle, if residual capacities of the battery packs are inconsistent, a carriage with a low-capacity battery pack has a risk of power outage, which causes the entire vehicle to quit the operation. Therefore, it is necessary to resolve the problem of inconsistent capacities of battery packs in carriages during the operation of a vehicle.

### SUMMARY

The present disclosure provides a new technical solution including a method for equalizing battery capacities of a vehicle.

According to a first aspect of this specification, a method for equalizing battery capacities of a vehicle is provided, which includes the following steps.

A largest battery capacity and a corresponding first carriage thereof and a smallest battery capacity and a corresponding second carriage thereof are determined based on a current capacity of a battery of each of carriages.

A first traction force and a second traction force are determined based on the largest battery capacity and the smallest battery capacity, where the first traction force is greater than the second traction force.

A first control command including the first traction force is outputted to the first carriage, and a second control command including the second traction force is outputted to the second carriage for equalizing battery capacities of the carriages of the vehicle.

The first traction force is greater than the second traction force.

In an embodiment, the method further includes the following steps.

A capacity difference between the largest battery capacity and the smallest battery capacity is calculated.

The first traction force and the second traction force are determined based on the largest battery capacity and the smallest battery capacity when the capacity difference is greater than a capacity difference threshold.

In an embodiment, the method further includes the following step. A first actual load value corresponding to the first carriage and a second actual load value corresponding to the second carriage are obtained.

That a first traction force and a second traction force are determined based on the largest battery capacity and the smallest battery capacity includes the following steps.

The first actual load value and the second actual load value are added, to obtain a total load value.

A first to-be-outputted load value and a second to-be-outputted load value are calculated based on the largest battery capacity, the smallest battery capacity, the total load value, and an adjustment coefficient.

The first traction force is determined based on the first to-be-outputted load value, and the second traction force is determined based on the second to-be-outputted load value.

In an embodiment, the method further includes the following steps.

The first to-be-outputted load value is adjusted to the first actual load value, and a difference between the total load value and the adjusted first to-be-outputted load value is determined as a new second to-be-outputted load value when it is determined that the first to-be-outputted load value is greater than the first actual load value.

The second to-be-outputted load value is adjusted to the second actual load value, and a difference between the total load value and the adjusted second to-be-outputted load value is determined as a new first to-be-outputted load value when it is determined that the second to-be-outputted load value is less than the second actual load value.

In an embodiment, the method further includes the following step. A current level value of a vehicle is obtained.

That a first traction force and a second traction force are determined based on the largest battery capacity and the smallest battery capacity includes the following steps.

A first to-be-outputted level value and a second to-be-outputted level value are calculated based on the largest battery capacity, the smallest battery capacity, the current level value, and the adjustment coefficient.

The first traction force is determined based on the first to-be-outputted level value, and the second traction force is determined based on the second to-be-outputted level value.

In an embodiment, the method further includes the following steps.

The first to-be-outputted level value is adjusted to the upper limit level value, and a new second to-be-outputted level value is determined based on the current level value and the adjusted first to-be-outputted level value when it is determined that the first to-be-outputted level value is greater than the upper limit level value.

The second to-be-outputted level value is adjusted to a lower limit level value and a new first to-be-outputted level value is determined based on the current level value and the adjusted second to-be-outputted level value when it is determined that the second to-be-outputted level value is less than the lower limit level value.

In an embodiment, the first actual load value and the second actual load value are calculated based on signals collected from one or more load sensors.

In an embodiment, the current level value is calculated based on a signal collected from a driver controller.

According to a second aspect of the specification, an electronic device is further provided, which includes a memory and a processor. The memory is configured to store executable instructions. The processor is configured to execute the executable instructions to perform the method for equalizing battery capacities of a vehicle according to the implementations of the first aspect of the specification.

According to a third aspect of the specification, a vehicle is further provided, which includes the electronic device in the second aspect of the specification.

The largest battery capacity and the corresponding first carriage thereof, and the smallest battery capacity and the corresponding second carriage thereof, are determined based on the current capacities of the batteries of all of the carriages; the first traction force and the second traction force are determined based on the largest battery capacity and the smallest battery capacity; the control command including the first traction force is outputted to the first carriage, and the control command including the second traction force is outputted to the second carriage, where the first traction force is greater than the second traction force.

### BRIEF DESCRIPTION OF THE DRAWINGS

The drawings that are incorporated into and constitute a part of the specification illustrate embodiments of the present disclosure, and are used to explain the principle of the present disclosure together with the description.

FIG. 1 is a schematic isolation diagram of a battery pack of a multi-marshalling vehicle in the related art.

FIG. 2 is a schematic structural diagram of an electronic device that may apply a method for equalizing battery capacities of a vehicle according to the present disclosure.

FIG. 3 is a schematic flowchart of the method for equalizing battery capacities of a vehicle according to an embodiment of the present disclosure.

FIG. 4 is a schematic diagram of starting and quitting a battery capacity equalization process.

FIG. 5 is a schematic diagram of a related device of a multi-marshalling vehicle that may apply the method for equalizing battery capacities of a vehicle according to the present disclosure.

FIG. 6 is a changing curve of capacities during running of a vehicle without applying the method for equalizing battery capacities of a vehicle according to the embodiments.

FIG. 7 is a changing curve of capacities during running of the vehicle applying the method for equalizing battery capacities of a vehicle according to the embodiments.

FIG. 8 is a schematic structural diagram of an apparatus for equalizing battery capacities of a vehicle according to an embodiment of the present disclosure.

FIG. 9 is a schematic diagram of a hardware structure of an example electronic device.

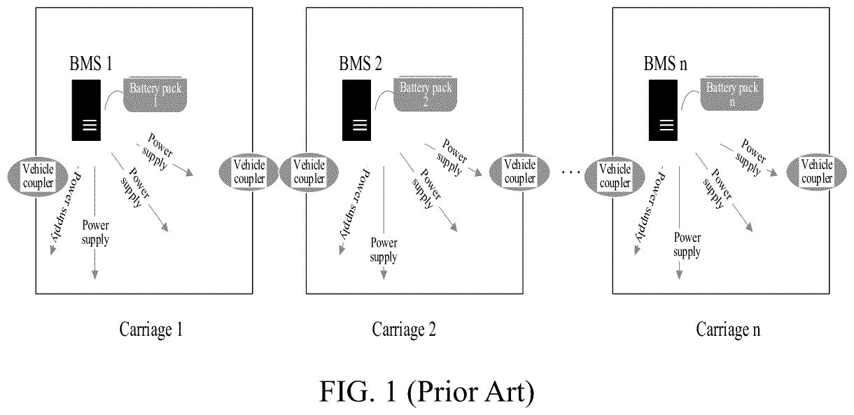

### DETAILED DESCRIPTION

Various embodiments of the present disclosure are described in detail with reference to the drawings. It should be noted that, unless otherwise specified, relative arrangement, numerical expressions, and numerical values of components and steps described in the embodiments do not limit the scope of the present disclosure.

The following description of the embodiments is merely illustrative, and does not constitute any limitation on the present disclosure and applications or use of the present disclosure.

Technologies, methods, and devices known to a person of ordinary skill in the related art may not be discussed in detail, but where appropriate, the techniques, the methods, and the devices should be considered as a part of the specification.

In all examples shown and discussed herein, any value should be construed as examples but not as a limitation. Therefore, some embodiments may have different values.

It should be noted that, similar reference numerals and letters represent similar terms in the following drawings. Therefore, once a component is defined in a drawing, the component does not need to be further discussed in subsequent drawings.

### Hardware Configuration

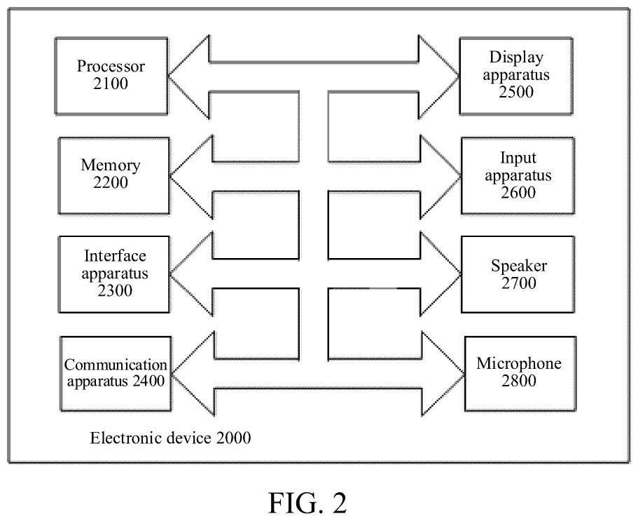

As shown in FIG. 2, an electronic device 2000, that may apply a method for equalizing battery capacities of a vehicle of the present disclosure, may include a processor 2100, a memory 2200, an interface apparatus 2300, a communication apparatus 2400, a display apparatus 2500, an input apparatus 2600, a speaker 2700, a microphone 2800, and the like.

The processor 2100 may be a mobile processor. The memory 2200 includes, for example, a read-only memory (ROM), a random access memory (RAM), a non-volatile memory such as a hard disk, and the like. The interface apparatus 2300 includes, for example, a USB interface and a headset jack. The communication apparatus 2400 may perform wired or wireless communication. The communication apparatus 2400 may include a near field communication apparatus, for example, any apparatus for near field wireless communication based on a near field wireless communication protocol such as an Hilink protocol, Wi-Fi (an IEEE 802.11 protocol), Mesh, Bluetooth, ZigBee, Thread, Z-Wave, NFC, UWB, and Li-Fi. The communication apparatus 2400 may further include a remote communication apparatus, for example, any apparatus for WLAN, GPRS, and 2G/3G/4G/5G remote communication. The display apparatus 2500 is, for example, a liquid crystal display or a touch display. The input apparatus 2600 may include, for example, a touch screen and a keyboard. The electronic device 2000 may output audio information through the speaker 2700 and collect audio information through the microphone 2800.

In this embodiment, the memory 2200 of the electronic device 2000 is configured to store instructions (e.g., the computer executable instructions). The instructions are configured to control the processor 2100 to perform operations to implement the method for equalizing battery capacities of a vehicle. A person skilled in the art may design the instructions based on the solutions disclosed in the present disclosure.

The present disclosure may include a portion of the multiple apparatuses of the electronic device 2000 shown in FIG. 2. For example, the electronic device 2000 includes the memory 2200, the processor 2100, the communication apparatus 2400, and the display apparatus 2500.

It should be understood that FIG. 2 shows one electronic device 2000 as an example, and a quantity of electronic devices 2000 is not limited.

### Method Embodiments

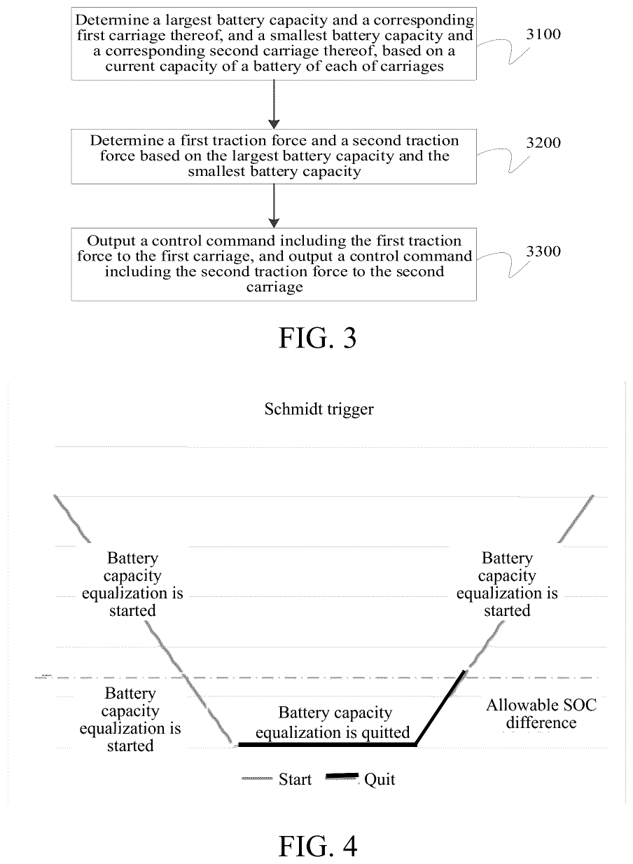

FIG. 3 is a flowchart of a method for equalizing battery capacities of a vehicle according to an embodiment of the present disclosure. The method may be implemented by an electronic device. The electronic device may be the electronic device 2000 shown in FIG. 2.

As shown in FIG. 3, the method for equalizing battery capacities of a vehicle in this embodiment may include the following step 3100 to step 3300.

Step 3100: A largest battery capacity and a corresponding first carriage thereof, and a smallest battery capacity and a corresponding second carriage thereof, are determined based on a current capacity of a battery of each of carriages.

A train control and management system (TCMS) is used for vehicle control. Main functions of the TCMS may include system control and monitoring, fault diagnosis, and the like. Main devices of the TCMS include a central control unit (Central Control Unit, CCU) and a remote input/output module (MOM). The CCU is configured to process calculations. The MOM is configured to implement input and output of signals for the CCU. The signals include a Controller Area Network (CAN) signal and an Ethernet signal.

In this step, the electronic device 2000 may obtain the current capacity of the battery of each carriage based on TCMS. In an embodiment, the current capacity may be a state of charge (SOC) of the battery, and is also referred to as a residual capacity, which indicates a proportion of the residual capacity of the battery after use for a period of time to a capacity of the battery in a fully charged state, and is usually expressed as a percentage in a range of 0% to 100%.

After the current capacities of the batteries of all of the carriages are obtained, the current capacities of the batteries of all of the carriages may be sorted, to determine the largest battery capacity and the smallest battery capacity. Then, the corresponding first carriage may be determined based on the largest battery capacity, and the corresponding second carriage may be determined based on the smallest battery capacity.

For example, it is assumed that the vehicle has three carriages: a carriage 1, a carriage 2, and a carriage 3. The obtained SOCs are 50%, 60%, and 55%, respectively. The SOCs are sorted as 60%-55%-50% in descending order. That is to say, the largest battery capacity is 60%, and the corresponding first carriage is the carriage 2. The smallest battery capacity is 50%, and the corresponding second carriage is the carriage 1.

Step 3200: A first traction force and a second traction force are determined based on the largest battery capacity and the smallest battery capacity.

Before this step, the electronic device 2000 may determine whether a battery capacity equalization process needs to be started. In an embodiment, the electronic device 2000 may calculate a capacity difference between the largest battery capacity and the smallest battery capacity, and compare the capacity difference with a preset capacity difference threshold. As shown in FIG. 4, a Schmidt trigger is used to set different conditions for starting and quitting the battery capacity equalization process, which can avoid repeated switching between starting and quitting the battery capacity equalization process.

When the capacity difference is greater than the preset capacity difference threshold, the battery capacity equalization process is started. That is to say, the operation of determining the first traction force and the second traction force based on the largest battery capacity and the smallest battery capacity is performed. The battery capacity equalization process is quitted or terminated when the capacity difference is 0. The battery capacity equalization process is started again when the capacity difference is greater than the preset capacity difference threshold again.

The factors that may affect a traction force outputted by a motor usually include a load and a level. Therefore, the two factors may be adjusted to set different traction forces, to consume different capacities, so that the battery capacities of all of the carriages tend to be consistent during the operation of the vehicle.

In an application scenario of equalizing the battery capacities through control of the load, the electronic device 2000 may further obtain a first actual load value corresponding to the first carriage and a second actual load value corresponding to the second carriage.

In an example, the first actual load value and the second actual load value are calculated based on signals collected from one or more load sensors.

The first actual load value and the second actual load value are added, to obtain a total load value; a first to-be-outputted load value and a second to-be-outputted load value are respectively calculated based on the largest battery capacity, the smallest battery capacity, the total load value, and a preset adjustment coefficient. The first traction force is determined based on the first to-be-outputted load value, and the second traction force is determined based on the second to-be-outputted load value.

For example, the electronic device 2000 may calculate the first to-be-outputted load value mₘₐₓ by using a formula

mₘₐₓ=(SOCₘₐₓ+n*ΔS)*Mₜₒₜₐₗ/(SOCₘₐₓ+SOCₘᵢₙ),

and calculate the second to-be-outputted load value mₘᵢₙ by using a formula

mₘᵢₙ=(SOCₘᵢₙ−n*ΔS)*Mₜₒₜₐₗ/(SOCₘₐₓ+SOCₘᵢₙ).

SOCₘₐₓ indicates the largest battery capacity. SOCₘᵢₙ indicates the smallest battery capacity. n indicates the preset adjustment coefficient. ΔS indicates the capacity difference. Mₜₒₜₐₗ indicates the total load value.

It should be noted that, the preset adjustment coefficient is selected based on a project requirement or experiment data. A larger n indicates a better SOC equalization effect, but n is limited by a boundary value of the load. The boundary value is in a range of Mₘᵢₙ to Mₘₐₓ.

The calculated first to-be-outputted load value of the first carriage and the calculated second to-be-outputted load value of the second carriage may exceed a range, for example, may be greater than Mₘₐₓ or less than Mₘᵢₙ. In an embodiment, when it is determined that the first to-be-outputted load value is greater than the first actual load value, the first to-be-outputted load value is adjusted to the first actual load value. In order to ensure that the traction force of the vehicle remains unchanged, it is necessary to ensure that a total load outputted to the motor remains unchanged. Therefore, after the first to-be-outputted load value is adjusted to the first actual load value, a difference between the total load value and the adjusted first to-be-outputted load value is determined as a new second to-be-outputted load value. When it is determined that the second to-be-outputted load value is less than the second actual load value, the second to-be-outputted load value is adjusted to the second actual load value, and a difference between the total load value and the adjusted second to-be-outputted load value is determined as a new first to-be-outputted load value.

In an application scenario of equalizing the battery capacities through control of the level, the electronic device 2000 may further obtain a current level value of the vehicle. In an example, the current level value is calculated based on a signal collected from a driver controller.

After the current level value is obtained, the electronic device 2000 may calculate a first to-be-outputted level value and a second to-be-outputted level value based on the largest battery capacity, the smallest battery capacity, the current level value, and the preset adjustment coefficient; and the electronic device 2000 may determine the first traction force based on the first to-be-outputted level value, and determines the second traction force based on the second to-be-outputted level value.

For example, the electronic device 2000 may calculate the first to-be-outputted level value aₘₐₓ by using a formula

aₘₐₓ=(SOCₘₐₓ+nΔS)*2a/(SOCₘₐₓ+SOCₘᵢₙ),

and calculate the second to-be-outputted level value aₘᵢₙ by using a formula

aₘᵢₙ=(SOCₘᵢₙ−n*ΔS)*2a/(SOCₘₐₓ+SOCₘᵢₙ).

SOCₘₐₓ indicates the largest battery capacity. SOCₘᵢₙ indicates the smallest battery capacity. n indicates the preset adjustment coefficient. ΔS indicates the capacity difference. a indicates the current level value.

It should be noted that, the preset adjustment coefficient is selected based on a project requirement or experiment data. A larger n indicates a better SOC equalization effect, but n is limited by a boundary value of the level. The boundary value is in a range of Aₘᵢₙ to Aₘₐₓ.

The calculated first to-be-outputted level value of the first carriage and the calculated second to-be-outputted level value of the second carriage may exceed a range, for example, may be greater than Aₘₐₓ or less than Aₘᵢₙ. When it is determined that the first to-be-outputted level value is greater than a preset upper limit level value, the first to-be-outputted level value is adjusted to the preset upper limit level value. In order to ensure that the traction force of the entire vehicle remains unchanged, it is necessary to ensure that the total level outputted to the motor remains unchanged. Therefore, after the first to-be-outputted level value is adjusted to the preset upper limit level value, a new second to-be-outputted level value is determined based on the current level value and the adjusted first to-be-outputted level value. For example, the new second to-be-outputted level value is calculated by using a formula aₘᵢₙ=2a−Aₘₐₓ. When it is determined that the second to-be-outputted level value is less than a preset lower limit level value, the second to-be-outputted level value is adjusted to the preset lower limit level value, and a new first to-be-outputted level value is determined based on the current level value and the adjusted second to-be-outputted level value. For example, the new first to-be-outputted level value is calculated by using a formula aₘₐₓ=2a−Aₘᵢₙ.

Step 3300: A control command including the first traction force is outputted to the first carriage, and a control command including the second traction force is outputted to the second carriage.

The first traction force is greater than the second traction force.

In an embodiment, the first traction force may be determined based on the first to-be-outputted load value or based on the first to-be-outputted level value. The second traction force may be determined based on the second to-be-outputted load value or based on the second to-be-outputted level value.

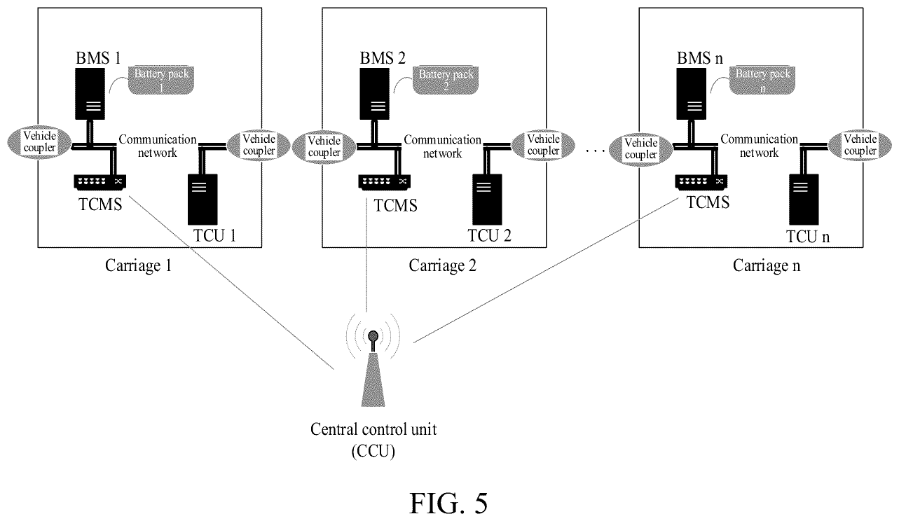

As shown in FIG. 5, devices related to the method for equalizing battery capacities of a vehicle in this embodiment may include a TCMS, a battery management system (BMS), and a traction control unit (TCU) arranged in each carriage. The TCMSs of all of the carriages are in communication. The BMS and the TCU of each carriage are isolated from each other.

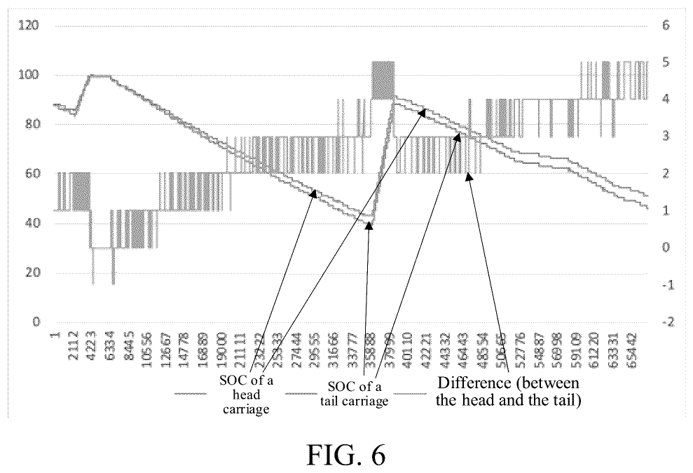

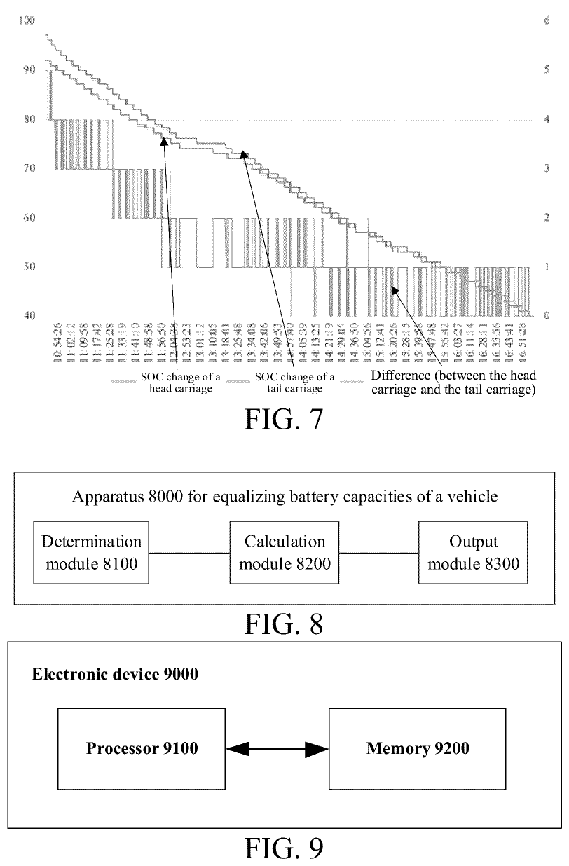

FIG. 6 is a changing curve of capacities during running of a vehicle without applying the method for equalizing battery capacities of a vehicle according to the embodiments. Since a head carriage has some power consuming devices, a residual SOC of a tail carriage is 5% greater than that of the head vehicle in case of the same initial SOC. When the initial capacities differ greatly, or due to factors such as a temperature and poor battery consistency, the SOCs differ even more during running. FIG. 7 is a changing curve of capacities during running of the vehicle applying the method for equalizing battery capacities of a vehicle according to the embodiments. A difference between the initial SOCs is 5%. During the running, the SOCs gradually become consistent and finally stabilize within 1%. The load is used as a condition for equalization control herein. A value of the preset adjustment coefficient n is 5.

The method for equalizing battery capacities of a vehicle in this embodiment is described in detail above with reference to the drawings. In this embodiment, the electronic device determines the largest battery capacity and the corresponding first carriage thereof and the smallest battery capacity and the corresponding second carriage thereof based on the current capacities of the batteries of all of the carriages; determines the first traction force and the second traction force based on the largest battery capacity and the smallest battery capacity; outputs the control command including the first traction force to the first carriage, and outputs the control command including the second traction force to the second carriage, where the first traction force is greater than the second traction force. In this way, a carriage with a high battery capacity outputs more traction forces and a carriage with a low battery capacity outputs fewer traction forces in case of a constant traction force of the entire vehicle, so that the battery capacities of different carriages tend to be consistent during operation of the vehicle.

### Apparatus Embodiments

FIG. 8 is a block diagram of an apparatus for equalizing battery capacities of a vehicle according to an embodiment of the present disclosure.

As shown in FIG. 8, an apparatus 8000 for equalizing battery capacities of a vehicle may include a determination module 8100, a calculation module 8200, and an output module 8300.

The determination module 8100 is configured to determine a largest battery capacity and a corresponding first carriage thereof and a smallest battery capacity and a corresponding second carriage thereof based on a current capacity of a battery of each of carriages. The calculation module 8200 is configured to determine a first traction force and a second traction force based on the largest battery capacity and the smallest battery capacity. The output module 8300 is configured to output a control command including the first traction force to the first carriage, and output a control command including the second traction force to the second carriage. The first traction force is greater than the second traction force.

In an embodiment, the calculation module 8200 is further configured to: calculate a capacity difference between the largest battery capacity and the smallest battery capacity; and perform the operation of determining the first traction force and the second traction force based on the largest battery capacity and the smallest battery capacity when the capacity difference is greater than a preset capacity difference threshold.

In an embodiment, the apparatus 8000 for equalizing battery capacities of a vehicle may further include an obtaining module. The obtaining module is configured to obtain a first actual load value corresponding to the first carriage and a second actual load value corresponding to the second carriage. The calculation module 8200 is configured to: add first actual load value and the second actual load value, to obtain a total load value; respectively calculate a first to-be-outputted load value and a second to-be-outputted load value based on the largest battery capacity, the smallest battery capacity, the total load value, and a preset adjustment coefficient; and determine the first traction force based on the first to-be-outputted load value, and determine the second traction force based on the second to-be-outputted load value.

In an embodiment, the apparatus 8000 for equalizing battery capacities of a vehicle may further include an adjustment module. The adjustment module is configured to: adjust the first to-be-outputted load value to the first actual load value and determine a difference between the total load value and the adjusted first to-be-outputted load value as a new second to-be-outputted load value when it is determined that the first to-be-outputted load value is greater than the first actual load value; and adjust the second to-be-outputted load value to the second actual load value and determine a difference between the total load value and the adjusted second to-be-outputted load value as a new first to-be-outputted load value when it is determined that the second to-be-outputted load value is less than the second actual load value.

In an embodiment, the obtaining module may be configured to obtain a current level value of a vehicle. The calculation module 8200 is configured to calculate a first to-be-outputted level value and a second to-be-outputted level value based on the largest battery capacity, the smallest battery capacity, the current level value, and the preset adjustment coefficient; and determine the first traction force based on the first to-be-outputted level value, and determine the second traction force based on the second to-be-outputted level value.

In an embodiment, the adjustment module may be configured to adjust the first to-be-outputted level value to a preset upper limit level value and determine a new second to-be-outputted level value based on the current level value and the adjusted first to-be-outputted level value when it is determined that the first to-be-outputted level value is greater than the preset upper limit level value; and adjust the second to-be-outputted level value to a preset lower limit level value and determine a new first to-be-outputted level value based on the current level value and the adjusted second to-be-outputted level value when it is determined that the second to-be-outputted level value is less than the preset lower limit level value.

In an embodiment, the first actual load value and the second actual load value are calculated based on signals collected from one or more load sensors. The current level value is calculated based on a signal collected from a driver controller.

The apparatus for equalizing battery capacities of a vehicle in this embodiment may be configured to perform the technical solution of the above method embodiments. Technical effects and implementation principles thereof are similar, and therefore are not described in detail herein.

### Electronic Device Embodiment

In this embodiment, an electronic device 9000 is provided.

As shown in FIG. 9, the electronic device 9000 may include a processor 9100 and a memory 9200. The memory 9200 is configured to store executable instructions. The processor 9100 is configured to run the electronic device 9000 to perform the method for equalizing battery capacities of a vehicle in any embodiment of the present disclosure based on control of the instructions.

### Medium Embodiment

An embodiment of the present disclosure provides a non-transitory computer-readable storage medium, which stores a computer program. The computer program, when executed by a processor, implements the method for equalizing battery capacities of a vehicle provided in any of the above embodiments.

The present disclosure may be a system, a method, and/or a computer program product. The computer program product may include a computer-readable storage medium, which carries computer-readable program instructions used to cause a processor to implement the aspects of the present disclosure.

The computer-readable storage medium may be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any appropriate combination thereof. More examples (a non-exhaustive list) of the computer-readable storage medium include: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital video disk (DVD), a memory stick, a floppy disk, a mechanical encoding device such as a punched card storing instructions or a protruding structure in a groove, and any appropriate combination thereof. The computer-readable storage medium used herein is not construed as an instantaneous signal, such as a radio wave or another freely propagated electromagnetic wave, an electromagnetic wave propagated through a waveguide or another transmission medium (such as an optical pulse passing through an optical fiber cable), or an electrical signal transmitted through a wire.

The computer-readable program instructions described herein may be downloaded from the computer-readable storage medium to computing/processing devices, or may be downloaded to an external computer or an external storage device through a network such as the Internet, a local area network (LAN), a wide area network (WAN), and/or a wireless network. The network may include a copper transmission cable, optical fiber transmission, wireless transmission, a router, a firewall, a switch, a gateway computer, and/or an edge server. A network adapter card or network interface in each of the computing/processing device receives the computer-readable program instructions from the network, and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or target code written in a combination of one or more programming languages. The programming languages include object-oriented programming languages such as Smalltalk and C++, and conventional procedural programming languages such as a “C” language or a similar programming language. The computer-readable program instructions may be completely executed on a user computer, partially executed on a user computer, executed as an independent software package, partially executed on a user computer and partially executed on a remote computer, or completely executed on a remote computer or a server. In a situation involving the remote computer, the remote computer may be connected to the user computer by using any type of network, including the LAN or the WAN, or may be connected to the external computer (for example, connected to the external computer through the Internet by using an Internet service provider). In some embodiments, an electronic circuit such as a programmable logic circuit, a field programmable gate array (FPGA), or a programmable logic array (PLA) is customized by using status information of the computer-readable program instructions. The electronic circuit may execute the computer-readable program instructions, thereby implementing the aspects of the present disclosure.

The aspects of the present disclosure are described herein with reference to the flowcharts and/or block diagrams of the method, apparatus (system), and computer program product in the embodiments of the present disclosure. It should be understood that each block in the flowcharts and/or block diagrams and a combination of the blocks in the flowcharts and/or block diagrams may be implemented through the computer-readable program instructions.

The computer-readable program instructions may be provided to a general purpose computer, a special purpose computer, or a processor of another programmable data processing apparatus, to produce a machine, so that the instructions generate an apparatus for implementing the functions/actions specified in one or more blocks in the flowcharts and/or block diagrams during execution of the instructions by the computer or the another programmable data processing apparatus. The computer-readable program instructions may be stored in the computer-readable storage medium. The instructions cause the computer, the programmable data processing apparatus, and/or another device to work in a manner. Therefore, the computer-readable medium storing the instructions includes an artifact, which includes the instructions for implementing the aspects of the functions/operations specified in one or more blocks in the flowcharts and/or block diagrams.

The computer-readable program instructions may be loaded to the computer, another programmable data processing apparatus, or another device, so that the computer, the another programmable data processing apparatus, or the another device performs a series of operations and steps to generate a computer-implemented process. In this way, the instructions executed on the computer, another programmable data processing apparatus, or another device implement the functions/operations specified in one or more blocks in the flowcharts and/or the block diagrams.

The flowcharts and block diagrams in the drawings show architectures, functions, and operations that may be implemented by the system, the method, and the computer program product in the embodiments of the present disclosure. In this regard, each block in the flowcharts or the block diagrams may represent a module, a program segment, or a part of the instructions. The module, the program segment, or the part of the instructions includes one or more executable instructions for implementing specified logical functions. In some alternative implementations, functions annotated in the blocks may occur out of the order annotated in the drawings. For example, two consecutive blocks may actually be executed in parallel, or may sometimes be executed in reverse order, which depends on the functions involved. It should also be noted that each block in the block diagrams and/or flowcharts and a combination of the blocks in the block diagrams and/or flowcharts may be implemented by a dedicated hardware-based system for performing specified functions or operations, or may be implemented in a combination of dedicated hardware and computer instructions. It is well-known for a person skilled in the art that implementations through hardware, software, and a combination of software and hardware are all equivalent.

The embodiments of the present disclosure are described above. The above description is an example and non-exhaustive, and is not limited to the disclosed embodiments. Many modifications and changes are apparent to a person of ordinary skill in the art without departing from the scope and spirits of the various embodiments that are described. The terms used herein are selected in such a way to provide the best explanation of the principles, practical applications of the embodiments, or technique improvements in the market, or cause another person of ordinary skill in the art to understand the embodiments disclosed herein. The scope of the present disclosure is defined by the appended claims.

What is claimed is:

1. A method for equalizing battery capacities of a vehicle, comprising:
determining, based on a current capacity of a battery of each of carriages, a largest battery capacity and a corresponding first carriage thereof, and a smallest battery capacity and a corresponding second carriage thereof;
determining, based on the largest battery capacity and the smallest battery capacity, a first traction force and a second traction force, wherein the first traction force is greater than the second traction force; and
outputting a first control command comprising the first traction force to the first carriage, and outputting a second control command comprising the second traction force to the second carriage for equalizing battery capacities of the carriages of the vehicle.

2. The method according to claim 1, the method further comprising:
calculating a capacity difference between the largest battery capacity and the smallest battery capacity,
wherein in response to the capacity difference is greater than a capacity difference threshold, the first traction force and the second traction force are determined based on the largest battery capacity and the smallest battery capacity.

3. The method according to claim 1, further comprising: obtaining a first actual load value corresponding to the first carriage and a second actual load value corresponding to the second carriage;
wherein the determining, based on the largest battery capacity and the smallest battery capacity, the first traction force and the second traction force comprises:
adding the first actual load value and the second actual load value, to obtain a total load value;
calculating a first to-be-outputted load value and a second to-be-outputted load value based on the largest battery capacity, the smallest battery capacity, the total load value, and an adjustment coefficient; and
determining the first traction force based on the first to-be-outputted load value, and determining the second traction force based on the second to-be-outputted load value.

4. The method according to claim 3, the method further comprising:
in response to determining that the first to-be-outputted load value is greater than the first actual load value, adjusting the first to-be-outputted load value to the first actual load value, and determining a difference between the total load value and the adjusted first to-be-outputted load value as a new second to-be-outputted load value; and
in response to determining that the second to-be-outputted load value is less than the second actual load value, adjusting the second to-be-outputted load value to the second actual load value, and determining a difference between the total load value and the adjusted second to-be-outputted load value as a new first to-be-outputted load value.

5. The method according to claim 1, further comprising: obtaining a current level value of a vehicle;
wherein the determining, based on the largest battery capacity and the smallest battery capacity, the first traction force and the second traction force comprises:
calculating a first to-be-outputted level value and a second to-be-outputted level value based on the largest battery capacity, the smallest battery capacity, the current level value, and an adjustment coefficient; and
determining the first traction force based on the first to-be-outputted level value, and determining the second traction force based on the second to-be-outputted level value.

6. The method according to claim 5, the method further comprising:
in response to determining that the first to-be-outputted level value is greater than an upper limit level value, adjusting the first to-be-outputted level value to the upper limit level value, and determining a new second to-be-outputted level value based on the current level value and the adjusted first to-be-outputted level value; and
in response to determining that the second to-be-outputted level value is less than a lower limit level value, adjusting the second to-be-outputted level value to the lower limit level value, and determining a new first to-be-outputted level value based on the current level value and the adjusted second to-be-outputted level value.

7. The method according to claim 3, wherein the first actual load value and the second actual load value are calculated based on signals collected from one or more load sensors.

8. The method according to claim 5, wherein the current level value is calculated based on a signal collected from a driver controller.

9. An electronic device, comprising a memory and a processor, the memory being configured to store executable instructions, wherein the processor is configured to execute the executable instructions to perform operations comprising:
determining, based on a current capacity of a battery of each of carriages, a largest battery capacity and a corresponding first carriage thereof, and a smallest battery capacity and a corresponding second carriage thereof;
determining, based on the largest battery capacity and the smallest battery capacity, a first traction force and a second traction force, wherein the first traction force is greater than the second traction force; and
outputting a first control command comprising the first traction force to the first carriage, and outputting a second control command comprising the second traction force to the second carriage for equalizing battery capacities of the carriages of a vehicle.

10. The electronic device according to claim 9, wherein the operations further comprise: obtaining a first actual load value corresponding to the first carriage and a second actual load value corresponding to the second carriage;
wherein the determining, based on the largest battery capacity and the smallest battery capacity, the first traction force and the second traction force comprises:
adding the first actual load value and the second actual load value, to obtain a total load value;
calculating a first to-be-outputted load value and a second to-be-outputted load value based on the largest battery capacity, the smallest battery capacity, the total load value, and an adjustment coefficient; and
determining the first traction force based on the first to-be-outputted load value, and determining the second traction force based on the second to-be-outputted load value.

11. The electronic device according to claim 10, wherein the operations further comprise:
in response to determining that the first to-be-outputted load value is greater than the first actual load value, adjusting the first to-be-outputted load value to the first actual load value, and determining a difference between the total load value and the adjusted first to-be-outputted load value as a new second to-be-outputted load value; and
in response to determining that the second to-be-outputted load value is less than the second actual load value, adjusting the second to-be-outputted load value to the second actual load value, and determining a difference between the total load value and the adjusted second to-be-outputted load value as a new first to-be-outputted load value.

12. The electronic device according to claim 9, wherein the operations further comprise: obtaining a current level value of a vehicle;
wherein the determining, based on the largest battery capacity and the smallest battery capacity, the first traction force and the second traction force comprises:
calculating a first to-be-outputted level value and a second to-be-outputted level value based on the largest battery capacity, the smallest battery capacity, the current level value, and an adjustment coefficient; and
determining the first traction force based on the first to-be-outputted level value, and determining the second traction force based on the second to-be-outputted level value.

13. The electronic device according to claim 12, wherein the operations further comprise:
in response to determining that the first to-be-outputted level value is greater than an upper limit level value, adjusting the first to-be-outputted level value to the upper limit level value, and determining a new second to-be-outputted level value based on the current level value and the adjusted first to-be-outputted level value; and
in response to determining that the second to-be-outputted level value is less than a lower limit level value, adjusting the second to-be-outputted level value to the lower limit level value, and determining a new first to-be-outputted level value based on the current level value and the adjusted second to-be-outputted level value.

14. The electronic device according to claim 10, wherein the first actual load value and the second actual load value are calculated based on signals collected from one or more load sensors.

15. The electronic device according to claim 12, wherein the current level value is calculated based on a signal collected from a driver controller.

16. A vehicle, comprising an electronic device comprising a memory and a processor, the memory being configured to store executable instructions, wherein the processor is configured to execute the executable instructions to perform operations comprising:
determining, based on a current capacity of a battery of each of carriages, a largest battery capacity and a corresponding first carriage thereof, and a smallest battery capacity and a corresponding second carriage thereof;
determining, based on the largest battery capacity and the smallest battery capacity, a first traction force and a second traction force, wherein the first traction force is greater than the second traction force; and
outputting a first control command comprising the first traction force to the first carriage, and outputting a second control command comprising the second traction force to the second carriage for equalizing battery capacities of the carriages of the vehicle.

17. The vehicle according to claim 16, wherein the operations further comprise: obtaining a first actual load value corresponding to the first carriage and a second actual load value corresponding to the second carriage;
wherein the determining, based on the largest battery capacity and the smallest battery capacity, the first traction force and the second traction force comprises:
adding the first actual load value and the second actual load value, to obtain a total load value;
calculating a first to-be-outputted load value and a second to-be-outputted load value based on the largest battery capacity, the smallest battery capacity, the total load value, and an adjustment coefficient; and
determining the first traction force based on the first to-be-outputted load value, and determining the second traction force based on the second to-be-outputted load value.

18. The vehicle according to claim 17, wherein the operations further comprise:
in response to determining that the first to-be-outputted load value is greater than the first actual load value, adjusting the first to-be-outputted load value to the first actual load value, and determining a difference between the total load value and the adjusted first to-be-outputted load value as a new second to-be-outputted load value; and
in response to determining that the second to-be-outputted load value is less than the second actual load value, adjusting the second to-be-outputted load value to the second actual load value, and determining a difference between the total load value and the adjusted second to-be-outputted load value as a new first to-be-outputted load value.

19. The vehicle according to claim 16, wherein the operations further comprise: obtaining a current level value of a vehicle;
wherein the determining, based on the largest battery capacity and the smallest battery capacity, the first traction force and the second traction force comprises:
calculating a first to-be-outputted level value and a second to-be-outputted level value based on the largest battery capacity, the smallest battery capacity, the current level value, and an adjustment coefficient; and
determining the first traction force based on the first to-be-outputted level value, and determining the second traction force based on the second to-be-outputted level value.

20. The vehicle according to claim 19, wherein the operations further comprise:
in response to determining that the first to-be-outputted level value is greater than an upper limit level value, adjusting the first to-be-outputted level value to the upper limit level value, and determining a new second to-be-outputted level value based on the current level value and the adjusted first to-be-outputted level value; and
in response to determining that the second to-be-outputted level value is less than a lower limit level value, adjusting the second to-be-outputted level value to the lower limit level value, and determining a new first to-be-outputted level value based on the current level value and the adjusted second to-be-outputted level value.
